(19) United States
(12) Patent Application Publication
(10) Pub. No.: US 2026/0256321 A1
(43) Pub. Date: Sep. 3, 2026

(54) ADJUSTABLE SHREDDER

(71) Applicant: Zhejiang Fullstar Technology Co., Ltd, Taizhou (CN)

(72) Inventor: Congqiang LU, Taizhou (CN)

(73) Assignee: Zhejiang Fullstar Technology Co., Ltd, Taizhou (CN)

(21) Appl. No.: 19/279,156

(22) Filed: Jul. 24, 2025

(30) Foreign Application Priority Data
Feb. 28, 2025 (CN) 202520353300.1

(51) Int. Cl. A47J 43/25

(52) U.S. Cl. CPC A47J 43/25

(57) ABSTRACT

An adjustable shredder includes a frame body. The frame body is provided inside with an upper panel and a lower panel. A discharge outlet between the upper panel and the lower panel is provided with a horizontal blade and a vertical blade. A back of the frame is provided with a lifting seat for adjusting a height of the vertical blade and a sliding seat for adjusting a height of the lower panel. One side of the sliding seat is provided with a handle for driving the sliding seat. One side of the lifting seat opposite to the handle is provided with a guide lug extending outward and tilted toward the lower panel. The adjustable shredder provided by the application has the advantages of simple structure, convenient use and high safety.

### CROSS-REFERENCE TO RELATES APPLICATIONS

This application claims priority to Chinese Patent Application No. 202520353300.1, filed on February 28, 2025, the content of which is incorporated herein by reference in its entirety.

### TECHNICAL FIELD

The application belongs to the technical field of vegetable cutters and relates to an adjustable shredder.

### BACKGROUND

The shredder (grater) is a commonly used kitchen utensil, mainly used for grating fruits and vegetables. In order to meet the diversified needs, adjustable shredders have become a development trend today. For example, Chinese Patent Publication CN208319085U discloses a grater cover plate and a grater, which include a cover body. The cover body includes a bottom plate, which is a sunken structure. A grating cutter for grating and a discharge port are arranged in the middle of the bottom plate, a grating panel is arranged on a bottom plate in front of the grating cutter, and an adjustment device for adjusting a height of an end of the grating panel adjacent to the grating cutter is arranged between the bottom plate and the grating panel.

The above grater can adjust upper and lower positions of adjusting pins by means of an adjusting knob to adjust the height of the grating panel, thereby achieving the purpose of adjusting a thickness of the grating. In order to achieve more complex adjustments, some graters also have adjustable grating cutters. By adjusting the height of the grating cutter, a cutting height of a grating vertical blade can be adjusted. When the vertical blade is fully retracted, it can also be switched to slicing mode.

When multiple adjustment structures are used, the layouts of the adjustment structures may affect each other because a more complex adjustment structure needs to be designed. Therefore, how to design an adjustment structure that is simple in structure and does not affect each other has become a very challenging technical problem in the art.

### SUMMARY

In view of the shortcomings in the prior art, the application provides an adjustable shredder, which has the advantages of simple structure, convenient use and high safety.

To solve the above-mentioned technical problem, the purpose of the application is achieved through the following technical solutions.

An adjustable shredder includes a frame body. The frame body is provided inside with an upper panel and a lower panel. A discharge outlet between the upper panel and the lower panel is provided with a horizontal blade and a vertical blade. A back of the frame is provided with a lifting seat for adjusting a height of the vertical blade and a sliding seat for adjusting a height of the lower panel. One side of the sliding seat is provided with a handle for driving the sliding seat. One side of the lifting seat opposite to the handle is provided with a guide lug extending outward and tilted toward the lower panel.

In the application, the sliding seat refers to an adjustment seat that slides in a horizontal direction, and the lifting seat refers to an adjustment seat that drives assemblies to rise and fall in a vertical direction.

In the above adjustable shredder, the discharge outlet, the lifting seat and the sliding seat are all arranged in an tilted and parallel manner, and the handle and the guide lug are respectively arranged at ends of the sliding seat and the lifting seat close to the middle of the frame body; further, the horizontal blade is fixed on the upper panel with a direction of a cutting edge consistent with a direction of the discharge outlet, a blade holder of the vertical blade is consistent with the direction of the discharge outlet, and the vertical blade is arranged perpendicular to the blade holder thereof.

In the above adjustable shredder, the guide lug and the lifting seat are integrally formed with each other, and a smooth transition is formed between the guide lug and a bottom of the lifting seat; the handle and the sliding seat are integrally formed with each other, and a bottom of the handle extends beyond a bottom of the frame body.

In the above adjustable shredder, the handle is U-shaped, and a groove in the middle of the handle forms a receiving structure for fingers; preferably, a width of the handle is greater than a width of a main body of the sliding seat.

In the above adjustable shredder, one end of the lower panel away from the discharge outlet is hinged to the frame body, and one end of the lower panel close to the discharge outlet is a movable end; an inner wall of the frame body is provided with horizontally-distributed slide grooves, and both ends of the sliding seat slide in the slide grooves respectively; a bottom of the lower panel is provided with a plurality of tilted guide blocks, and the tilted guide blocks abut against the sliding seat and adjust a height of the movable end of the lower panel.

In the above adjustable shredder, further, a plurality of limit grooves are arranged in the slide groove, a plurality of limit planes are arranged on the tilted guide block, and the limit grooves cooperate with the limit planes to form a plurality of gear adjustment structures.

In the above adjustable shredder, the sliding seat may also use other structures to drive the lower panel: for example, a tilted slide groove is arranged on the inner wall of the frame body, and when the sliding seat slides in the slide groove, a height thereof also changes accordingly, thereby driving a height of the movable end of the lower panel to change.

In the above adjustable shredder, the vertical blade is arranged in a vertical sliding manner in the frame body, and a stud is arranged at the bottom thereof; an axially-limiting lifting knob is rotatably arranged in the lifting seat, and the lifting knob is screwed to the vertical blade to drive the vertical blade to rise and fall; the lower panel is provided with a plurality of knife holes that cooperate with the vertical blade; further, the frame body is provided with a mounting seat, the lifting seat is fixedly connected to the mounting seat through a fastener, and the vertical blade slides vertically in the mounting seat.

In the above adjustable shredder, the lifting seat may also use other structures to drive the vertical blade: for example, a cam that abuts against the blade holder of the vertical blade is arranged in the lifting seat, and the vertical blade may be driven to rise and fall by rotating the cam.

Compared with the prior art, the application has the following beneficial effects.

The application provides an adjustable shredder, which may adjust the height of the lower panel by driving a sliding seat through the handle, and adjust the height of the vertical blade through the lifting seat, thereby realizing the adjustability of the shredder. Meanwhile, the guide lug is arranged on the lifting seat; when the fingers hold the handle and move toward the lifting seat, the fingers will move in the direction of the guide lug, and then move out of the gap between the sliding seat and the lifting seat in the process of approaching, so as to avoid the fingers being pinched by the gradually-narrowing gap between the sliding seat and the lifting seat during the adjustment of the sliding seat. Therefore, the application has the advantages of simple structure, convenient use and high safety.

### BRIEF DESCRIPTION OF THE DRAWINGS

FIG. 1 is a three-dimensional view of the application.

FIG. 2 is another three-dimensional view of the application.

FIG. 3 is a cross-sectional view in a length direction of the application.

FIG. 4 is an enlarged view of a portion of FIG. 3.

### DETAILED DESCRIPTION OF THE EMBODIMENTS

The application is further described below with reference to the accompanying drawings and the embodiments.

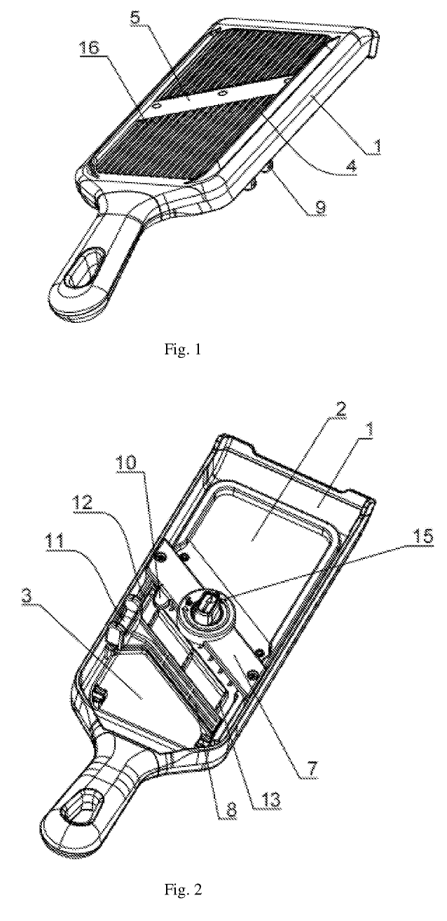

With reference to FIGS. 1 to 4, an adjustable shredder includes a frame body 1, wherein the frame body 1 is provided inside with an upper panel 2 and a lower panel 3, and a discharge outlet 4 between the upper panel 2 and the lower panel 3 is provided with a horizontal blade 5 and a vertical blade 6; a back of the frame body is provided with a lifting seat 7 for adjusting a height of the vertical blade 6 and a sliding seat 8 for adjusting a height of the lower panel 3; one side of the sliding seat 8 is provided with a handle 9 for driving the sliding seat 8, and one side of the lifting seat 7 opposite to the handle 9 is provided with a guide lug 10 extending outward and tilted toward the lower panel 3.

With reference to FIGS. 1 and 2, the usage of the embodiment is: the material to be cut is slided along the lower panel 3 toward the discharge port 4; the material first passes through the vertical blade 6, where the material is cut vertically by a blade on the vertical blade 6, and then continues to move forward to pass through the horizontal blade 5, where the material is cut horizontally by a blade of the horizontal blade 5, and finally the material is cut into filaments and discharged from the discharge port 4. When a height of the vertical blade 6 is required to be adjusted, the vertical blade 6 is driven to rise and fall by the lifting seat 7; when a height of the lower panel 3 is required to be adjusted, the handle 9 is pushed horizontally with a finger, and the height of the lower panel 3 is changed by a horizontal movement of the sliding seat 8; when the handle 9 is moved close to the lifting seat 7, the finger on one side of the handle 9 close to the lifting seat 7 will first contact the guide lug 10, the handle 9 will continue to be pushed, and the finger will move out of the gap along a direction of the guide lug 10 to a bottom of the lifting seat 7, so that the finger will not be caught in the gap and injured.

Preferably, the discharge outlet 4, the lifting seat 7 and the sliding seat 8 are all arranged in an tilted and parallel manner, and the handle 9 and the guide lug 10 are respectively arranged at ends of the sliding seat 8 and the lifting seat 7 close to the middle of the frame body 1; further, the horizontal blade 5 is fixed on the upper panel 2 with a direction of a cutting edge consistent with a direction of the discharge outlet 4, a blade holder of the vertical blade 6 is consistent with the direction of the discharge outlet 4, and the vertical blade 6 is arranged perpendicular to the blade holder thereof.

In order to facilitate production and improve strength, the guide lug 10 and the lifting seat 7 are integrally formed with each other, and a smooth transition is formed between the guide lug 10 and a bottom of the lifting seat 7; the handle 9 and the sliding seat 8 are integrally formed with each other, and a bottom of the handle 9 extends beyond a bottom of the frame body 1; through the handle 9 extending beyond the bottom of the frame body, when in adjustment, the shredder does not need to be turned over to the back, and the finger may be inserted into the bottom of the shredder to operate, so that changes in the height of the lower panel 3 may be observed intuitively.

Preferably, the handle 9 is U-shaped, and a groove 11 in the middle of the handle 9 forms a receiving structure for fingers; when in pushing or pulling operations, the fingers may also be placed in the groove 11 for pushing and pulling to further prevent the fingers from being pinched; preferably, in order to make the handle 9 have sufficient strength, a width of the handle 9 is greater than a width of a main body of the sliding seat 8.

In the embodiment, with reference to FIG. 2, the specific structure of the sliding seat 8 driving the lower panel 3 is: one end of the lower panel 3 away from the discharge outlet 4 is hinged to the frame body, and one end of the lower panel close to the discharge outlet 4 is a movable end; an inner wall of the frame body is provided with horizontally-distributed slide grooves 12, and both ends of the sliding seat 8 slide in the slide grooves 12 respectively; a bottom of the lower panel 3 is provided with a plurality of tilted guide blocks 13, and the tilted guide blocks 13 abut against the sliding seat 8 and adjust a height of the movable end of the lower panel 3.

Further, a plurality of limit grooves are arranged in the slide groove 12, a plurality of limit planes are arranged on the tilted guide block 13, and the limit grooves cooperate with the limit planes to form a plurality of gear adjustment structures; both sides of the limit groove are tilted structures, and when the sliding seat 8 is pushed hard, the tilted surface may be crossed to enter the next limit groove.

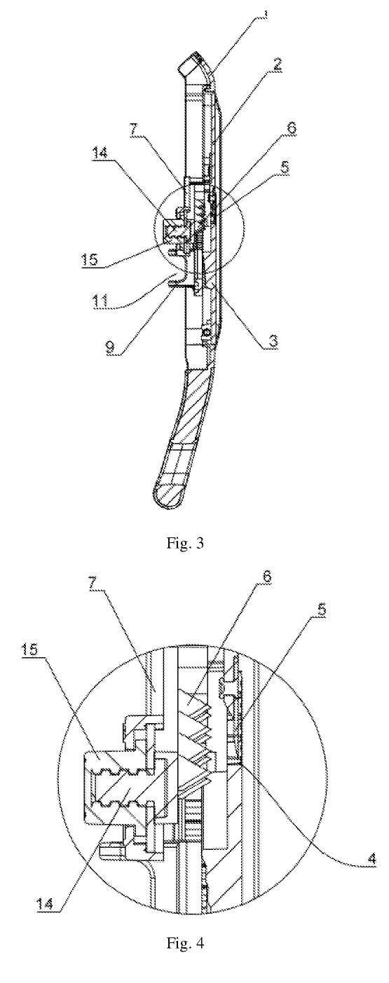

In the embodiment, with reference to FIG. 3, the specific structure of the lifting seat 7 driving the vertical blade 6 is: the vertical blade 6 is arranged in a vertical sliding manner in the frame body, and a stud 14 is arranged at the bottom thereof; an axially-limiting lifting knob 15 is rotatably arranged in the lifting seat 7, and the lifting knob 15 is screwed to the vertical blade 6 to drive the vertical blade to rise and fall; the lower panel 3 is provided with a plurality of knife holes 16 that cooperate with the vertical blade 6; further, the frame body is provided with a mounting seat, the lifting seat 7 is fixedly connected to the mounting seat through a fastener, and the vertical blade 6 slides vertically in the mounting seat.

The above embodiments are only preferred embodiments of the application, and do not limit the protection scope of the application accordingly. Therefore, all equivalent changes made in accordance with the structure, shape, and principle of the application shall be covered by the protection scope of the application.

What is claimed is:

1. An adjustable shredder, comprising a frame body, wherein
the frame body is provided inside with an upper panel and a lower panel, and a discharge outlet between the upper panel and the lower panel is provided with a horizontal blade and a vertical blade;
a back of the frame body is provided with a lifting seat for adjusting a height of the vertical blade and a sliding seat for adjusting a height of the lower panel; and
one side of the sliding seat is provided with a handle for driving the sliding seat, and one side of the lifting seat opposite to the handle is provided with a guide lug extending outward and tilted toward the lower panel.

2. The adjustable shredder according to claim 1, wherein the discharge outlet, the lifting seat and the sliding seat are all arranged in an tilted and parallel manner, and the handle and the guide lug are respectively arranged at ends of the sliding seat and the lifting seat close to the middle of the frame body.

3. The adjustable shredder according to claim 1, wherein the guide lug and the lifting seat are integrally formed with each other, and a smooth transition is formed between the guide lug and a bottom of the lifting seat; the handle and the sliding seat are integrally formed with each other, and a bottom of the handle exceeds a bottom of the frame body.

4. The adjustable shredder according to claim 1, wherein the handle is U-shaped, and a groove in the middle of the handle forms a receiving structure for fingers.

5. The adjustable shredder according to claim 1, wherein one end of the lower panel away from the discharge outlet is hinged to the frame body, and one end of the lower panel close to the discharge outlet is a movable end;
an inner wall of the frame body is provided with horizontally-distributed slide grooves, and both ends of the sliding seat slide in the slide grooves respectively; and
a bottom of the lower panel is provided with a plurality of tilted guide blocks, and the tilted guide blocks abut against the sliding seat and adjust a height of the movable end of the lower panel.

6. The adjustable shredder according to claim 1, wherein the vertical blade is arranged in a vertical sliding manner in the frame body, and a stud is arranged at the bottom thereof; an axially-limiting lifting knob is rotatably arranged in the lifting seat, and the lifting knob is screwed to the stud to drive the stud to rise and fall; the lower panel is provided with a plurality of knife holes that cooperate with the vertical blade.
